(19) United States
(12) Patent Application Publication
(10) Pub. No.: US 2025/0305088 A1
(43) Pub. Date: Oct. 2, 2025

(54) METHODS AND SYSTEMS FOR LEACHING A METAL-BEARING MATERIAL

(71) Applicant: FREEPORT MINERALS CORPORATION, Phoenix, AZ (US)

(72) Inventor: Sarah Lyons, Vail, AZ (US)

(73) Assignee: FREEPORT MINERALS CORPORATION, Phoenix, AZ (US)

(21) Appl. No.: 18/616,794

(22) Filed: Mar. 26, 2024

(51) Int. Cl. C22B 15/00; C22B 1/16; C22B 3/02; C22B 3/16

(52) U.S. Cl. CPC C22B 15/0067; C22B 1/16; C22B 3/02; C22B 3/16; C22B 15/0008

(57) ABSTRACT

Methods for recovering a metal value from a metal-bearing material are provided. The method comprises leaching the metal-bearing material with a leaching solution to produce a pregnant leaching solution, wherein the leaching solution comprises the raffinate, the chelating agent, an oxidant, and a low concentration of a silver agent, wherein the low concentration of the silver agent is in the range of about 10 ppm to about 80 ppm, and wherein the metal-bearing material comprises a concentration of iron, and recovering the metal value from the pregnant leaching solution to produce the raffinate.

### FIELD OF INVENTION

The present disclosure generally relates to recovering metal values from metal-bearing materials, and specifically to leaching methods and systems comprising acids, oxidants, citric acid or citrates, and silver to extract metal values from high iron containing ores.

### BACKGROUND

Advances in leaching technology have made it possible to recover copper values from secondary copper sulfides, such as for example, chalcopyrite, chalcocite and covellite. To break copper-iron-sulfur bonds in these and other minerals, oxidative conditions can be used. Although sulfuric acid, typically present in leaching, carries some oxidizing potential, much of the driving force for leaching sulfides comes from the oxidation potential of ferric iron present in solution from iron bearing minerals such as pyrite. When ferric iron oxidizes copper sulfide minerals, the ferric iron is reduced to ferrous iron. The ferrous iron can be oxidized back to ferric iron to further oxidize copper sulfide minerals if an oxidant such as oxygen or another oxidant is present. For this re-oxidation to occur, a source of oxygen or another oxidant is used.

Although these leaching methods comprising acid and oxidant are relatively effective at metal extraction, implementing improvements to traditional processing techniques to increase extraction efficiency in historically difficult to leach ore is economically advantageous. For example, chalcopyrite is the most abundant copper mineral, however, due to its highly refractory nature it is very difficult to leach with traditional leaching practices. Chalcopyrite's dissolution is slow and will generally stop leaching due to passivation of the mineral surface at a low level of metal recovery. Consequently, this pervasive copper mineral's extraction potential remains unrealized.

Additionally, in many heap leaching operations, gangue materials consume high amounts of acid, particularly seen when attempting to leach skarns. If insufficient acid is added, the pH of the leach solutions within a stockpile will rise. As pH rises, ferric iron begins to precipitate out of solution as a viscous and sticky mineral known as jarosite. Jarosite is detrimental for several reasons, but most notably because it coats various materials in the stockpile, which can inhibit beneficial reactions that would otherwise occur to benefit copper recovery. Further, ore bodies that require high additions of acid will generally be seen as noneconomic to leach due to the high cost of such additions.

One solution proposed to address this issue is reagent addition to the leaching process. Previous experiments and teachings have shown that the addition of silver is particularly beneficial in improving copper recovery. However, it is an exceedingly expensive reagent often lost in downstream processes, rendering it economically infeasible for practical use. While beneficial, the cost of the silver additions needed outweighs the additional profit gained from improved recovery. Accordingly, there is an ongoing need for leaching methods and systems with improved cost and efficiency to leach ore bodies that are generally considered infeasible.

### SUMMARY

In accordance with various embodiments of the present disclosure, it has now been surprisingly discovered that citric acid or a citrate salt thereof, in combination with an oxidant and low concentrations of a silver agent, acts as a catalyst for enhancing copper recovery and as a stabilizing agent for iron and silver ions, mitigating the formation of jarosite while retaining silver in solution for reuse in future leaching cycles.

In one aspect of the present invention, a method for recovering a metal value from a metal-bearing material is provided. The method includes leaching the metal-bearing material with a leaching solution to produce a pregnant leaching solution, wherein the leaching solution comprises a raffinate, citric acid, hydrogen peroxide, and optionally a low concentration of a silver agent, wherein the low concentration of the silver agent is in the range of about 10 ppm to about 80 ppm, and wherein the metal-bearing material comprises a concentration of iron. The method further includes recovering the metal value from the pregnant leaching solution to produce the raffinate. In various embodiments, the method may further include agglomerating the metal-bearing material with an agglomeration solution before the step of leaching to form an agglomerated metal-bearing material, wherein the agglomeration solution comprises the raffinate, citric acid, hydrogen peroxide, and a low concentration of the silver agent, wherein the low concentration of the silver agent does not exceed about 1% by weight.

In various embodiments, the concentration of iron is more than bout 2 g/L. In various embodiments, the oxidant is hydrogen peroxide, the chelating agent is citric acid, and the silver agent is silver citrate. In various embodiments, the agglomeration solution comprises a concentration of hydrogen peroxide in the range of about 1% to about 10% by weight and a concentration of citric acid in the range of about 1 g/L to about 10 g/L. In various embodiments, the low concentration of the silver agent in the agglomeration solution is about 0.025% to about 0.075% by weight. In various embodiments, the metal-bearing material is chalcopyrite. In various embodiments, the raffinate comprises a retained concentration of the silver agent.

In various embodiments, the method further comprises forming at least a portion of a heap with the agglomerated metal-bearing material after the step of agglomerating. In various embodiments, the leaching comprises leaching the heap with the leaching solution. In various embodiments, the leaching further comprises an injection of air or oxygen into the heap.

In another aspect of the present invention, a system for recovering a metal value from a metal-bearing material is provided. The system includes the metal-bearing material comprising a concentration of iron. The system further includes a leaching system configured to leach the metal-bearing material with a leaching solution to produce a pregnant leach solution, wherein the leaching solution comprises the raffinate, citric acid, hydrogen peroxide, and optionally a low concentration of a silver agent, and wherein the low concentration of the silver agent is in the range of about 10 ppm to about 80 ppm. The system further includes a recovery system configured to recover the metal value from the pregnant leaching solution and produce the raffinate. In various embodiments, the system may further include an agglomeration system positioned before the leaching system and configured to agglomerate the metal-bearing material with an agglomeration solution to produce an agglomerated metal-bearing material, wherein the agglomeration solution comprises the raffinate, citric acid, hydrogen peroxide and a low concentration of a silver agent, wherein the low concentration of the silver agent does not exceed about 1% by weight.

### BRIEF DESCRIPTION OF THE DRAWINGS

The subject matter is pointed out with particularity and claimed distinctly in the concluding portion of the specification. A more complete understanding, however, may best be obtained by referring to the detailed description and claims when considered in connection with the following drawing FIGURES.

FIG. 1 is a flow diagram illustrating a leaching method in accordance with various embodiments of the present invention.

### DETAILED DESCRIPTION

The following description is merely exemplary in nature and is not intended to limit the present invention, its applications, or its uses. It should be understood that throughout the drawings, corresponding reference numerals indicate like or corresponding parts and features. The description of specific examples indicated in various embodiments of the present invention are intended for purposes of illustration only and are not intended to limit the scope of the invention disclosed herein. Moreover, recitation of multiple embodiments having stated features is not intended to exclude other embodiments having additional features or other embodiments incorporating different combinations of the stated features.

Furthermore, the detailed description of various embodiments herein makes reference to the accompanying drawing FIGURES, which show various embodiments by way of illustration. While the embodiments are described in sufficient detail to enable those skilled in the art to practice the invention, it should be understood that other embodiments may be realized, and that logical and mechanical changes may be made without departing from the spirit and scope of the present invention. Thus, the detailed description herein is presented for purposes of illustration only and not of limitation. For example, steps or functions recited in descriptions of any method, system, or process may be executed in any order and are not limited to the order presented. Moreover, any of the step or functions thereof may be outsourced to or performed by one or more third parties. Furthermore, any reference to singular includes plural embodiments, and any reference to more than one component may include a singular embodiment.

In general, the present disclosure relates to methods and systems for recovering metal values from metal-bearing materials and, more specifically, to leaching methods and systems using citric acid or salts thereof, an oxidant, and low concentrations of a silver agent to leach an iron containing ore. Various embodiments of the present invention provide a method for recovering a metal value from a metal-bearing material. The method includes agglomerating the metal-bearing material with an agglomeration solution to form an agglomerated metal-bearing material, wherein the agglomeration solution includes a raffinate, a chelating agent, and an oxidant, and wherein the metal-bearing material comprises a concentration of iron, leaching the agglomerated metal-bearing material with a leaching solution to produce a pregnant leaching solution, wherein the leaching solution includes the raffinate, the chelating agent, and a low concentration of a silver agent, wherein the low concentration of the silver agent does not exceed about 1% by weight, and recovering the metal value from the pregnant leaching solution to produce the raffinate.

Examples of metal values include, but are not limited to, copper, nickel, zinc, silver, gold, germanium, lead, arsenic, antimony, chromium, molybdenum, rhenium, tungsten, iron, ruthenium, osmium, cobalt, rhodium, iridium, palladium, platinum, uranium, or rare earth metals. More preferably, the metal values can be copper, nickel, and/or zinc. Most preferably, the metal value is copper.

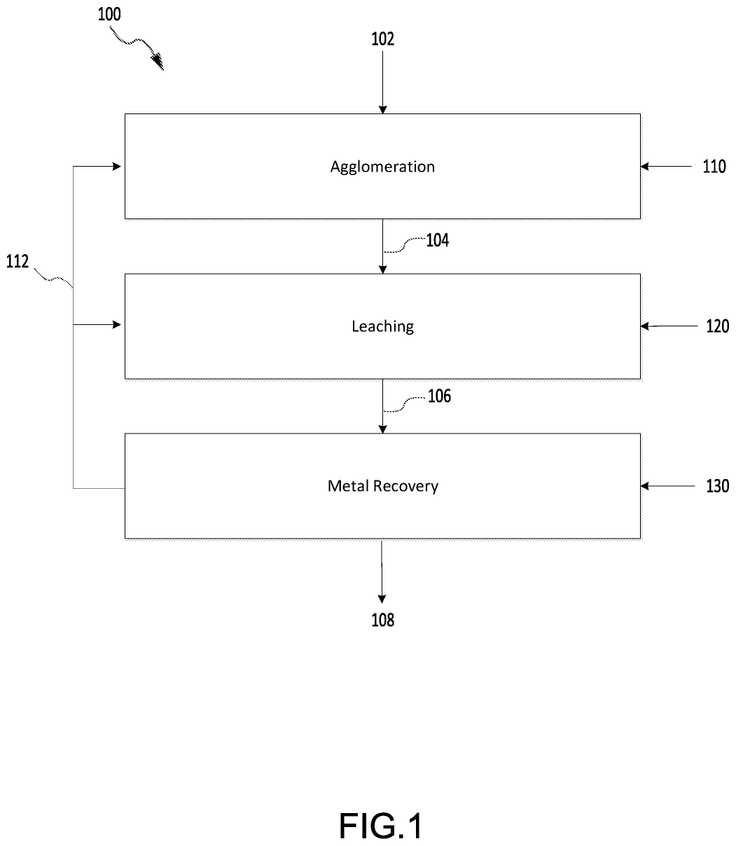

Referring now to FIG. 1, a method 100 is shown for recovering a metal value 108 from a metal-bearing material 102. The metal-bearing material 102 may be an ore, a concentrate, a process residue, or any other material from which metal values may be recovered. Metal values, such as those described herein, may be recovered from the metal-bearing material 102. In an aspect of the present invention, the metal-bearing material 102 may comprise a refractory metal sulfide.

In accordance with various embodiments, the metal-bearing material 102 may comprise chalcocite, pyrite, chalcopyrite, arsenopyrite, bornite, covellite, digenite, cobaltite, enargite, galena, greenockite, millerite, molybdenite, orpiment, pentlandite, pyrrhotite, sphalerite, stibnite, and/or any other suitable metal-bearing ore material. Preferably, the metal-bearing material 102 may comprise primary or secondary sulfides such as chalcocite, bornite, pyrite, or chalcopyrite, or a blend of such mineral species. Various aspects and embodiments of the present invention, however, prove particularly advantageous in connection with the recovery of copper from copper sulfide ores such as, for example, chalcopyrite (CuFeS₂), chalcocite (Cu₂S), bornite (CusFeS₄), covellite (CuS), enargite (Cu₃AsS₄), digenite (Cu₉S₅) and mixtures thereof. Thus, the metal-bearing material 102 may be a copper ore or concentrate, and preferably, is a copper sulfide ore or concentrate. Most preferably, the metal-bearing material 102 is chalcopyrite.

In an aspect of the present invention, all or a portion of the metal-bearing material 102 may be further processed via size classification and/or crushing to achieve a desired particle size distribution, such that, substantially all of the particles are of a size to allow effective agglomeration of the metal-bearing material 102 and allow for optimal economic recovery of the contained metal value 108.

In accordance with various embodiments of the present invention, the metal-bearing material 102 has a particle distribution of any combination of particle distributions. The particle distribution may have a combination of fine and coarse particles. Any particle distribution that maximizes agglomeration and/or curing, and metal recovery is useful. The conditions and parameters of the metal leaching method 100 disclosed herein may be adjusted to achieve an optimized result for leaching and metal recovery.

In accordance with various embodiments, the metal-bearing material 102 may be subjected to agglomeration process 110 to produce an agglomerated metal-bearing material 104. In various embodiments, the agglomeration process 110 may include combining the metal-bearing material 102 with an agglomeration solution. In various embodiments, the agglomeration solution may comprise a raffinate 112. In various embodiments, the agglomeration solution may further include an oxidizing agent. In various embodiments, the oxidizing agent may oxidize a metal component in the metal-bearing material 102. In various embodiments, the oxidizing agent may further react with the metal-bearing material 102 to release heat and acid. In various embodiments, the oxidizing agent may include hydrogen peroxide, or any other suitable and known oxidant. In the preferred embodiment, hydrogen peroxide is initially effective at leaching copper sulfide ores, however, due to their refractory nature and high concentration of iron, the oxidation reaction generates significant amounts of ferric iron in solution, which eventually precipitates as jarosite. This jarosite precipitation coats the mineral surfaces, preventing further leaching from occurring. Thus, hydrogen peroxide is infeasible to use alone to improve the recovery of the metal value 108 from the metal-bearing material 102.

As such, the agglomeration solution may further comprise a chelating agent. In various embodiments, the chelating agent may include citric acid or salts thereof. In various embodiments, citric acid and salts thereof may comprise any amorphous or crystalline form of citric acid, including any hydrate and any mono-, di-, or tri-citrate salt, wherein the counterion of a citrate anion comprises any alkali metal, any alkaline earth metal, or any transition metal cation. Di- and tri-citrate salts of citric acid need not have a single species of cation, and thus citrate salts include di- and tri-salts with any combination of counter-cations. Non-limiting examples of citric acid and salts thereof include citric acid monohydrate, disodium citrate, trisodium citrate, ferric citrate (iron (III) citrate), and tricalcium citrate (commonly referred to as simply “calcium citrate”). Since metal leaching conditions in accordance with the present disclosure are typically acidic, it often does not matter what citrate salt is added to a leach heap since all citrate salts will be converted to citric acid in the acidic leaching conditions. Further, it is expected that ferric citrate (iron (III) citrate) will be present in a heap leaching system that includes pyrite, citric acid, or salts thereof, oxidant and acid.

In various embodiments, citric acid helps keep ions in solution, preventing them from precipitating out and keeping them chemically available for use in further reactions. In various embodiments, citric acid finds particular use controlling iron ions, preventing jarosite precipitation and ultimately passivation.

In various embodiments, the agglomeration solution may further comprise a silver agent. Silver has long been considered as a catalyst for leaching operations as it has been found to result in vast increases in metal recovery. However, historically, it has been viewed as impractical to use as a reagent as it is very expensive and is prone to precipitate out in solution, preventing the re-use of it in subsequent leaching cycles. Additionally, prior teachings indicate that silver concentration directly correlated with copper recovery, resulting in the addition of high concentrations of silver and further increasing operational cost.

This results in a significant operational cost as the reagent is lost and continuous additions are required to replace it. This issue is particularly prevalent in the leaching of sulfide ores, wherein the combination of silver ions with iron ions results in the precipitation of silver jarosite. Thus, using a silver agent alone in the leaching process is generally operationally infeasible, as the costs of continuously replacing the silver agent would quickly outweigh the benefits of improved recovery.

In the instant invention, citric acid has surprisingly been found to keep silver ions in solution, preventing the silver agent from being lost in downstream processes and allowing it to continue operating as an effective catalyst in downstream leaching process 120. The synergistic effect of citric acid and silver thus renders silver an economic option for sulfide leaching. Additionally, contrary to conventional knowledge, it has been found that when leaching metal-bearing materials containing high amounts of iron, only small amounts of silver are needed to obtain significant recovery improvements and, if additions are added over the optimal concentration, recovery is in fact inhibited. Therefore, the instant invention allows silver to be an economically feasible reagent option.

In various embodiments, the agglomeration process 110 may combine the metal-bearing material 102 with the raffinate 112, citric acid, hydrogen peroxide, and silver agent to form the agglomerated metal-bearing material 104. In various embodiments, the agglomeration process 110 may cure the metal-bearing material 102 in the agglomeration solution to form a cured metal-bearing material. In various embodiments, curing may render the metal-bearing material 102 amenable to subsequent leaching processes.

In various embodiments, the raffinate 112, citric acid, hydrogen peroxide, and silver agent may be mixed prior to combination with the metal-bearing material 102. In an exemplary embodiment, a raffinate provided from any other metal recovery process (not shown) may be used to form the agglomerated metal-bearing material 104. In various embodiments, the raffinate 112 may be an aqueous product of a solvent extraction process, such as, for example, a conventional solvent extraction/electrowinning (SX/EW) process, or a direct electrowinning (DEW) process. In various embodiments, the raffinate 112 may comprise water and an acid, such as, for example, sulfuric acid.

In an aspect of the invention, the agglomeration process 110 may involve the metal-bearing material 102 being combined with the raffinate 112, citric acid, hydrogen peroxide, and silver agent in an agglomeration drum. An agglomeration drum may be any suitable agglomeration drum known in the art. In accordance with an exemplary embodiment, the raffinate 112, citric acid, hydrogen peroxide, and silver agent may be combined with the metal-bearing material 102 within the agglomeration drum. The metal-bearing material 102 is mixed with the raffinate 112, citric acid, hydrogen peroxide, and silver agent in the agglomeration drum to produce the agglomerated metal-bearing material 104. The agglomeration process 110 may further include the blending of coarse portions and fine portions of the metal-bearing material 102, in order to maximize metal recovery while maintaining heap permeability in a heap leaching.

In various embodiments, the agglomeration process 110 may comprise resting the metal-bearing material 102 in the agglomeration solution for a certain period of time. In various embodiments, the certain period of time may be adjusted to achieve an optimized result for agglomeration and metal recovery. In various embodiments, the metal-bearing material 102 may rest in the agglomeration solution for any duration in the range of about 0 to about 8 days. In various embodiments, the metal-bearing material 102 may rest in the agglomeration solution for any duration in the range of about 0 to about 4 days. In various embodiments, the metal-bearing material 102 may rest in the agglomeration solution for any duration on the order of at least 1 day.

The quantity of the raffinate 112, citric acid, hydrogen peroxide, and silver agent in the agglomeration solution may vary with respect to the type and/or quantity of metal-bearing material 102 used. In various embodiments, the agglomeration solution may include a certain concentration of hydrogen peroxide. In various embodiments, the concentration of hydrogen peroxide in the agglomeration solution may be adjusted to achieve an optimized result for agglomeration and metal recovery. In various embodiments, the agglomeration solution may comprise a concentration of hydrogen peroxide in the range of about less than about 15% by weight, preferably about 1 to about 10% by weight, more preferably on the order of about 8.4% by weight. In various embodiments, the agglomeration solution may include a certain concentration of citric acid. In various embodiments, the concentration of citric acid in the agglomeration solution may be adjusted to achieve an optimized result for agglomeration and metal recovery. In various embodiments, the agglomeration solution may comprise a concentration of citric acid in the range of about less than about 15 g/L, preferably about 1 to about 10 g/L, more preferably on the order of about 3 g/L. In various embodiments, the agglomeration solution may include a certain concentration of the silver agent. In various embodiments, the silver agent may comprise any source of silver suitable for the leaching of metals, such as, for example, soluble or slightly soluble salts of silver, such as silver nitrate, silver sulfate, silver chloride, or preferably silver citrate. However, silver may be added in any suitable form such that silver ions introduce elemental silver into the process. In various embodiments, the agglomeration solution may comprise a concentration of the silver agent in the range of less than about 0.1% by weight, preferably about 0.025% to about 0.075% by weight, more preferably about 0.0315% by weight.

When leaching sulfide ores, higher temperatures result in increased recoveries. However physical efforts, such as, for example, applying external heat sources or injecting air/oxygen into leaching solutions or a leach heap, to increase the temperature of a leaching operation are often costly and noneconomic. It is more advantageous to utilize exothermic chemical reactions to reach the desired temperature. In various embodiments, the addition of hydrogen peroxide to the agglomeration solution generates heat through pyrite oxidation, resulting in a lower cost way to raise and maintain the temperature of a leaching operation to optimal levels.

Further, in various embodiments, the addition of hydrogen peroxide to the agglomeration solution produces acid. Many sulfide ores comprise large amounts of gangue, or waste, material. Gangue materials consume large amounts of acid, requiring leaching operations to expend significant resources continuously adding acid to further the leaching process. As such, many otherwise accessible and metal-rich ore bodies are viewed as noneconomic to leach. However, as hydrogen peroxide oxidizes pyrite, acid is generated, ensuring that little to no further acid additions are required to continue the leaching reactions.

After the agglomeration process 110, the agglomerated metal-bearing material 104 moves to a leaching process 120. In various embodiments, the leaching process 120 comprises combining the agglomerated metal-bearing material 104 with a leaching solution to form a pregnant leach solution 106. In various embodiments, the leaching solution comprises the raffinate 112 and citric acid.

In various embodiments, the concentration of citric acid in the leaching solution may be adjusted to achieve an optimized result for leaching and metal recovery. In various embodiments, the leaching solution may comprise a concentration of citric acid in the range of about less than about 15 g/L, preferably about 1 to about 10 g/L, more preferably on the order of about 5 g/L.

In various embodiments, metal-bearing material 102 may skip agglomeration process 110 entirely, such as, for example, when metal-bearing material 102 contains such a low concentration of metal value 108 that performing particle separation and an agglomeration process 110 would not be economic. In such embodiments, wherein metal-bearing material is not exposed to an agglomeration solution that comprises the silver agent, the leaching solution may further comprise the silver agent. In various embodiments, the leaching solution comprises a concentration of the silver agent in the range of about 10 ppm to about 80 ppm, preferably in the range of about 25 ppm to about 60 ppm, more preferably about 40 ppm.

In various embodiments, the leaching process 120 may comprise a heap leaching. In various embodiments, the heap leaching may comprise stacking or forming the agglomerated metal-bearing material 104 into a heap or a portion of a heap. In various embodiments, the heap leaching may comprise leaching the heap with the leaching solution after the heap is formed. In another aspect of the invention, the leaching process 120 may comprise any other known leaching method, such as a column or shake flask leaching.

As discussed above, a widespread issue with leaching sulfide ore is the tendency for jarosite to precipitate. This not only results in passivation of the ore, inhibiting the leaching solution from reaching the mineral surface, but also, when applied to heap leaching, creates permeability issues within the heap as the precipitates plug up flow paths within the heap. Another benefit of utilizing citric acid in the leaching solution is in addition to keeping iron ions in solution, citric acid also dissolves precipitated iron back into solution, restoring permeability and leaching potential.

In various embodiments, after leaching process 120, the pregnant leach solution 106 is subjected to a metal recovery process 130 to produce the metal value 108 and the raffinate 112. In various embodiments, the metal recovery process 130 may comprise a direct electrowinning (DEW) process. In another exemplary embodiment, the metal recovery process 130 may comprise a solvent extraction and electrowinning (SX/EW) process.

In various embodiments, the raffinate 112 may be recirculated and reused in the method 100. In various embodiments, the raffinate 112 may be reused in the agglomeration process 110 as a component of the agglomeration solution. In various embodiments, the raffinate 112 may be reused in the leaching process 120 as a component of the leaching solution. In various embodiments, citric acid, hydrogen peroxide, and the silver agent may be added to the raffinate 112 to form an agglomeration solution to agglomerate the metal-bearing material 102. In various embodiments, citric acid may be added to the raffinate 112 to form a leaching solution to leach the agglomerated metal-bearing material 104. In other embodiments, citric acid and the silver agent may be added to the raffinate 112 to form a leaching solution to leach metal-bearing material 102. In various embodiments, due to the retention effect citric acid has on silver ions, the raffinate 112 may comprise a retained concentration of the silver agent after leaching process 120 and metal recovery process 130. This silver-containing raffinate may provide further benefits to leaching recovery as it is reused in the agglomeration process 110 and leaching process 120 and minimize supplementary silver additions needed for future leaching cycles.

In an aspect of the invention, part or all of the metal leaching method 100 may be carried out under a certain pressure and temperature. In various embodiments, the agglomeration process 110, the leaching process 120, and the metal recovery process 130 may be carried out under a certain pressure and temperature. In various embodiments, the pressure and/or temperature may be adjusted to achieve an optimized result for agglomeration, leaching and/or metal recovery.

In various embodiments, the agglomeration process 110, the leaching process 120, and/or the metal recovery process 130 may be carried out under atmospheric pressure. In various embodiments, the agglomeration process 110, the leaching process 120, and/or the metal recovery process 130 may be carried out under another pressure that differs from atmospheric pressure. In various embodiments, the agglomeration process 110, the leaching process 120, and/or the metal recovery process 130 may be carried out under an ambient temperature, such as 20-22° C. In various embodiments, the agglomeration process 110, the leaching process 120, and/or the metal recovery process 130 may be carried out under another temperature, such as 23-60° C.

As discussed above, silver has been widely studied as a catalyst in leaching processes. Several papers have proposed chemical reactions to explain the interactions between silver and chalcopyrite. In Electrochemistry in silver catalysed ferric sulfate leaching of chalcopyrite, Miller et. al., Dep't Metallurgy & Metallurgical Eng'g Univ. of Utah, pp. 327-328 (1981) proposed the following interaction:

Ag₂S(surface)+2Fe³⁺→2Ag⁺+2Fe²⁺+S⁰

However, subsequent studies by Dutrizac (The leaching of silver sulphide in ferric ion media, Dutrizac, J. E., 35 Hydrometallurgy, pp. 275-292 (1994)) and Nazari et. al. (The role of silver-enhanced pyrite in enhancing the electrical conductivity of sulfur product layer during chalcopyrite leaching in the Galvanox™ process, Nazari, G., et. al., Hydrometallurgy pp. 113-114, 177-184 (2012)) demonstrated that this reaction was likely not thermodynamically favorable.

The instant invention, on the contrary to teachings in the art, has surprisingly found that a combination of high ferric and low silver concentrations may make the above interaction not just possible but practical. The key to this reaction is performing it in ore with high levels of iron ions and relatively low levels of silver addition. It has been found that as silver additions increase passed the optimal dose, metal recovery will decrease significantly. This discovery further contributes to the favorable economics of the instant invention as not only does citric acid prevent the silver from precipitating out, which enables it to be reused in future leach cycles and reduces future required additions of silver, but also the initial concentration of silver is kept low, minimizing startup operational costs immediately. The instant invention therefore provides an economically feasible way to utilize silver in leaching operations.

The Examples set forth herein are illustrative of exemplary embodiments of the present invention. The process, conditions and parameters reflected therein are intended to exemplify various aspects of the invention and are not intended to limit the scope of the claimed invention.

### Example 1

Two specimens of copper-containing ore were subject to a leaching method disclosed in the present invention. Specimen 1 contained 0.198% total copper and 16.87% total iron. Specimen 2 contained 0.096% total copper and 2.38% total iron. First, 25 grams of 140 mesh ore were added to 15 mL of agglomeration solution in a 250 mL Erlenmeyer shake flask. The agglomeration solution contained a raffinate produced from a copper leaching process, citric acid, hydrogen peroxide, and silver citrate. The concentration of citric acid and hydrogen peroxide in the agglomeration solution was 5 g/L and 8.4% respectively, while the concentration of silver citrate was 0.63%. The ore then rested in the agglomeration solution for 24 hours. Next, citric acid and a further addition of raffinate were added to the shake flask to begin the leaching process. The concentration of citric acid was 5 g/L.

The following 2 groups of leaching operations were carried out, as listed in Table 1. Except those conditions and reagents listed in Table 1, the two groups of leaching operations were carried out under the same conditions with the same reagents, as described above. The variations in iron concentration was used to demonstrate the effect of iron ions in the silver leaching process.

TABLE 1
Impacts of Iron Concentration on Silver Leaching

| Group No. | Total Iron in Ore (%) | Cu Recovery (%) |
|---|---|---|
| 1 | 16.87 | 41 |
| 2 | 2.38 | 20 |

As shown in Table 1, ore with a higher concentration of iron ions shows a greater recovery when used in combination with silver, demonstrating that there is likely a thermodynamically favorable reaction in chalcopyrite leaching with low doses of silver in the presence of high iron.

### Example 2

A specimen of copper-containing ore was subject to a leaching method disclosed in the present invention. The ore contained 0.198% total copper and 16.87% total iron. First, 25 grams of 140 mesh ore were added to 15 mL of agglomeration solution in a 250 mL Erlenmeyer shake flask. The agglomeration solution contained a raffinate produced from a copper leaching process, citric acid, hydrogen peroxide, and silver citrate. The concentration of citric acid and hydrogen peroxide in the agglomeration solution were 5 g/L and 8.4% respectively, while the concentration of silver citrate ranged from 0.0315% to 1.89%. The concentration of silver was varied to demonstrate the negative impact of silver concentration on copper recovery as silver is increased past its optimal dosage. The ore then rested in the agglomeration solution for 24 hours. Next, citric acid and a further addition of raffinate were added to the shake flask to begin the leaching process. The concentration of citric acid was 5 g/L.

The following 6 groups of leaching operations were carried out, as listed in Table 2. Except those conditions and reagents listed in Table 2, the six groups of leaching operations were carried out under the same conditions with the same reagents, as described above.

TABLE 2
Impact of Silver Concentration on Copper Ore

| Group No. | Silver Citrate (%) | Cu Recovery (%) |
|---|---|---|
| 1 | 0 | 25 |
| 2 | 0.0315 | 85 |
| 3 | 0.1575 | 72 |
| 4 | 0.315 | 75 |
| 5 | 0.63 | 41 |
| 6 | 1.89 | 38 |

As can be seen in Table 2, the optimal level of silver citrate concentration is very low, only 0.0315%, resulting in a copper recovery of 85%. Past this optimal level, a diminishing level of copper recovery is seen, demonstrating that too much silver can actually have an inhibiting effect on copper recovery. It can be concluded then that only low concentrations of silver citrate should be added to leaching operations.

The instant invention renders historically infeasible to leach ore bodies amenable to efficient metal recovery, and finds particular use with sulfide ore such as, for example, high iron containing ores like chalcopyrite. The use of an oxidant, preferably hydrogen peroxide, oxidizes the ore, providing access to previously passivated mineral while also releasing heat and acid. The production of acid further benefits the leaching of sulfide ores as they generally consume significant amounts of acid, rendering them noneconomic to process. However, hydrogen peroxide also generates high quantities of iron in solution, leading to jarosite precipitation and extreme passivation. The use of a chelating agent, preferably citric acid, is thus required to work in combination with hydrogen peroxide in order to keep iron in solution and prevent jarosite precipitation, promoting permeability in the leaching heap and allowing hydrogen peroxide to continue acting as an oxidant.

Silver has been historically known to improve metal recovery but is generally not used in practice in leaching operations due to its high cost and likelihood of being lost in downstream processes, rendering it noneconomic and infeasible. However, it was surprisingly found that the use of citric acid in combination with silver citrate will work to keep silver in solution, preventing it from being lost as precipitated silver jarosite, and allowing it to be reused, keeping reagent costs economic. Additionally, the combination of silver citrate with sulfuric acid, a common component of raffinate, produces citric acid, minimizing the need for outside additions of reagents required by the instant invention. While the exact mechanisms of silver's reaction with chalcopyrite are as yet unknown, the experiments discussed above indicate that the above equation is a thermodynamically favorable chemical reaction at low doses of silver and high concentration of ferric, a finding that is contrary to prior teachings in the art.

The synergistic effect of the three reagents—hydrogen peroxide, citric acid, and silver citrate—in tandem result in a sustainable, cost effective, and efficient method for recovering metal values from historically hard to leach ore bodies.

As discussed above, the present invention includes a metal leaching method utilizing hydrogen peroxide and citric acid to improve the efficiency of metal extraction operations. The present invention has been described with reference to various exemplary embodiments. However, many changes, combinations, and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In addition, the techniques described herein may be extended or modified for use with other metal extraction processes. These and other changes or modifications are intended to be included within the scope of the present claims.

The present invention has been described above with reference to a number of exemplary embodiments. It should be appreciated that the particular embodiments shown and described herein are illustrative of the invention and its best mode and are not intended to limit in any way the scope of the invention as set forth in the claims. Those skilled in the art having read this disclosure will recognize that changes and modifications may be made to the exemplary embodiments without departing from the scope of the present invention. For example, various aspects and embodiments of this invention may be applied to recovery of metals other than copper, such as nickel, zinc, cobalt, and others. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

It is believed that the disclosure set forth above encompasses at least one distinct invention with independent utility. While the invention has been disclosed in the exemplary forms, the specific embodiments thereof as disclosed and illustrated herein are not to be considered in a limiting sense as numerous variations are possible. Equivalent changes, modifications and variations of various embodiments, materials, compositions and methods may be made within the scope of the present invention, with substantially similar results. The subject matter of the inventions includes all novel and non-obvious combinations and sub combinations of the various elements, features, functions and/or properties disclosed herein.

Benefits, other advantages, and solutions to problems have been described herein with regard to specific embodiments. However, the benefits, advantages, solutions to problems, and any element or combination of elements that may cause any benefit, advantage, or solution to occur or become more pronounced are not to be construed as critical, required, or essential features or elements of any or all the claims or the invention. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above.

What is claimed is:

1. A method for recovering a metal value from a metal-bearing material, comprising:
agglomerating the metal-bearing material with an agglomeration solution, wherein the agglomeration solution comprises a raffinate, citric acid, and hydrogen peroxide;
leaching the metal-bearing material with a leaching solution to produce a pregnant leaching solution, wherein the leaching solution comprises the raffinate, citric acid, and hydrogen peroxide, and wherein the metal-bearing material comprises a concentration of iron;
adding a low concentration of a silver agent, wherein the silver agent is added in the agglomeration solution, and wherein the low concentration of the silver agent is greater than 0% by weight but does not exceed about 1% by weight; and
recovering the metal value from the pregnant leaching solution to produce the raffinate, wherein the raffinate comprises a retained concentration of the silver agent of greater than 0% by weight, and wherein the raffinate is rendered amenable for reuse in the agglomerating or the leaching without further additions of the silver agent.

2. (canceled)

3. The method of claim 1, wherein the concentration of iron is more than about 2 g/L.

4. The method of claim 1, wherein the silver agent is silver citrate.

5. The method of claim 1, wherein the leaching solution comprises a concentration of hydrogen peroxide in the range of about 1% to about 10% by weight.

6. The method of claim 1, wherein the leaching solution comprises a concentration of citric acid in the range of about 1 g/L to about 10 g/L.

7. The method of claim 1, wherein the agglomeration solution comprises a concentration of citric acid in the range of about 1 g/L to about 10 g/L and a concentration of hydrogen peroxide in the range of about 1% to about 10% by weight.

8. (canceled)

9. The method of claim 1 wherein the low concentration of the silver agent is in the range of about 0.025% to about 0.075% by weight.

10. The method of claim 1, further comprising forming at least a portion of a heap with the agglomerated metal-bearing material after the step of agglomerating.

11. The method of claim 1, wherein the metal-bearing material is chalcopyrite.

12. The method of claim 10, wherein leaching further comprises an injection of air or oxygen into the heap.

13-20. (canceled)

21. An improved method for recovering a metal value from a metal-bearing material, wherein the metal-bearing material comprises a concentration of iron, and the method includes leaching the metal-bearing material with a leaching solution comprising a raffinate to produce a pregnant leaching solution, and the metal value is recovered from the pregnant leaching solution to produce the raffinate, wherein the improvement comprises, the leaching solution comprising the raffinate, citric acid, hydrogen peroxide, and a silver agent in a concentration in a range on the order of about 10 ppm to about 80 ppm, wherein the raffinate produced from metal recovery includes a retained concentration of the silver agent that is greater than 0% by weight, and wherein the raffinate is rendered amenable for reuse in the leaching without further additions of the silver agent.
